(19) United States
(12) Patent Application Publication
(10) Pub. No.: US 2013/0078353 A1
(43) Pub. Date: Mar. 28, 2013

(54) Sugar-Free Frozen Beverage With Fiber

(71) Applicants: Sandra C. Ryan, Kennesaw, GA (US); Shaun B. Gatipon, Kennesaw, GA (US)

(72) Inventors: Sandra C. Ryan, Kennesaw, GA (US); Shaun B. Gatipon, Kennesaw, GA (US)

(73) Assignee: The Coca-Cola Company, Atlanta, GA (US)

(21) Appl. No.: 13/624,385

(22) Filed: Sep. 21, 2012

Related U.S. Application Data
(60) Provisional application No. 61/538,088, filed on Sep. 22, 2011.

(51) Int. Cl. A23L 2/385; A23G 9/04

(52) U.S. Cl. CPC A23L 2/385; A23G 9/045
USPC 426/548; 426/590; 426/524

(57) ABSTRACT

The present invention relates generally to the field of beverages and beverage concentrates. In particular, the invention relates to a novel sugar-free beverage concentrate with fiber. In preferred embodiments, said beverage concentrate is frozen or transiently maintained in a temperature range near the freezing point of water. The present disclosure also relates to a sugar-free beverage concentrate with fiber that is low in calories.

### BACKGROUND OF THE INVENTION

1. Field of the Invention

The present invention relates generally to the field of beverages and beverage concentrates. In particular, the invention relates to a novel sugar-free beverage concentrate with fiber. In preferred embodiments, said beverage concentrate is frozen or transiently maintained in a temperature range near the freezing point of water. The present disclosure also relates to a sugar-free beverage concentrate with fiber that is low in calories.

2. Description of Related Art

There are numerous frozen carbonated beverages (FCBs) and frozen non-carbonated beverages (FNCBs) available in the marketplace. The development of such beverages often begins with the analysis and identification of problems associated with and shortcomings of known FCBs and FNCBs. As described in WO 2007/064740, known FCB products have historically been limited to full calorie FCBs that are supplemented with sugars that include but are not limited to sucrose, glucose, fructose and high fructose corn syrup (HFCS).

Low calorie and sugar free FCBs and FNCBs have recently been described, e.g. in U.S. Pat. No. 7,094,437 and U.S. Pat. App. Pub. No. 2009/0280232. However, the further combination of these properties with nutritional supplements, such as fiber, vitamins, minerals, beneficial plant extracts, and combinations thereof, would result in FCBs and FNCBs that address the needs of more dietary conscious consumers or those who require the additional intake of such supplements, e.g. for addressing or reducing symptoms or conditions associated with medical diseases and/or disorders. Thus, there exists a need for healthier FCBs and FNCBs that exhibit the taste, dispensability and stability properties preferred by consumers.

### SUMMARY OF THE INVENTION

One aspect of the present invention relates to a sugar-free beverage concentrate comprising fiber. In preferred embodiments, said beverage concentrate is capable of being dispensed using any suitable beverage dispenser known in the relevant art. The invention also relates to a sugar-free beverage concentrate comprising fiber that is freezable. Further provided are sugar-free beverage concentrates comprising fiber that are low calorie. In non-limiting embodiments of the inventions, the fiber content of the sugar-free beverage concentrate is present in a weight/volume percentage of between about 0.1% and about 30%, preferably between about 1% and about 25%, more preferably between about 10% and about 25% and even more preferably between about 15% and about 25%.

In a further aspect, a beverage concentrate in accordance with the present disclosure may be carbonated or is capable of being carbonated prior to being dispensed as a consumable beverage product. In another aspect of the present invention, the beverage concentrate is a non-carbonated beverage, including but in no way limited to coffee, cocoa, tea, daily, fruit juice, vegetable juice, pulp containing and non-pulp containing fruit flavored beverages, sports beverages and flavored water. In some embodiments, said beverage concentrate further comprises one or more of sucralose, acesulfame potassium (also known as potassium acesulfame and acesulfame-K), aspartame, alitame, saccharin, neohesperidin dihydrochalcone, cyclamate, neotame, advantame and salts thereof.

In certain embodiments, the beverage concentrate may further comprise a polyol. In some embodiments, said polyol is selected from the group consisting of erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, hydrogenated starch hydrolysate (HSH), sugar alcohols and salts thereof. In specific embodiments, a beverage concentrate in accordance with the present disclosure contains the polyol erythritol. In further embodiments, a beverage concentrate in accordance with the present invention contains one or more steviol glycoside(s) and/or compositions comprising the same, such as those described in U.S. Pat. No. 8,107,168 and U.S. Patent Publication Nos. 2008/02922764 and 2007/0292582. In still further embodiments, a beverage concentrate in accordance with the present invention contains one or more dulcosides, including but in no way limited to dulcosides A and B. In other embodiments, a beverage concentrate in accordance with the present invention contains one or more rebaudioside(s), including but not limited to Rebiana, rebaudiosides A, B, C, D, E, F, X and/or compositions comprising the same, such as those described in U.S. Pat. Nos. 8,030,481 and 8,107,168 and U.S. Patent Publication Nos. 2011/0160311 and 2011/0195161.

Another aspect of the invention relates to a method of making a sugar-free, fibrous carbonated beverage comprising (a) combining the beverage concentrate of claim 1 with water; and (b) dispensing the sugar-free, fibrous carbonated beverage. In yet another aspect of the present invention, the combination of said beverage concentrate and said water are subjected to a freezable temperature prior to step (b).

Yet another aspect of the invention relates to a method of making a sugar-free, fibrous non-carbonated beverage comprising (a) combining the beverage concentrate of claim 1 with water; and (b) dispensing the sugar-free, fibrous non-carbonated beverage. In further embodiments, the combination of said beverage concentrate and said water are subjected to a freezable temperature prior to step (b).

Another aspect of the invention relates to the use of flavoring components in the fibrous, sugar free beverage concentrate that includes but is in no way limited to caffeine, phosphoric acid, caramel color, propylene glycol, ethanol, phosphoric acid, citric acid, malic acid, tartaric acid, lactic acid, fumaric acid, ascorbic acid, cinnamic acid, mixtures thereof and salts produced therefrom, fruit flavors including lemon, orange, lime, cherry, strawberry, raspberry, grape, grapefruit, cola, root beer, coffee, tea, dairy, cocoa, vegetable flavors and extracts, botanical flavors including flavors and other extracts derived from grains, oats, nuts, bark, roots and leaves and mixtures thereof.

Yet another aspect of the current invention involves the use of optional ingredients which may be present in the fibrous, sugar free beverage concentrate according to the present invention including preservatives, colorants, saponins, foaming agents, vitamins including but not limited to vitamins A, B₃, B₆, B₁₂, C and E, minerals including but not limited to magnesium, potassium and calcium and salts thereof, fruit juice, vegetable juice and tea solids. Preservatives may include any such compounds known in the relevant art, including but not limited to potassium benzoate, sodium benzoate, potassium sorbate, and EDTA. In addition, colorants can include any colorants suitable for use in food and beverage applications, including but by no means limited to artificial colors, natural colors including caramel color, and fruit and vegetable juice extracts. Saponins or foaming agents can include any known foaming agents, including but not limited to Quillaia extract, Yucca extract and propylene glycol alginate. In further aspects, beverage concentrates of the present invention optionally comprise maltodextrin and trehalose.

### DETAILED DESCRIPTION OF THE INVENTION

The instant invention provides compositions relating to a sugar-free beverage concentrate comprising fiber and methods related thereto. Fiber is an essential component to the human diet that is derived primarily from plants. In recent years, fiber supplements and/or food additives have been marketed to consumers for a variety of nutritional and health purposes, including but not limited to the treatment of various gastrointestinal disorders, lowering cholesterol levels, reducing risk of colon cancer and losing weight. Fiber supplementation may be beneficial for alleviating symptoms of and managing irritable bowel syndrome, wherein such symptoms include diarrhea, constipation and abdominal discomfort. Prebiotic soluble fiber, such as inulin or oligosaccharides, may contribute to relief from inflammatory bowel disease, as in Crohn's disease, ulcerative colitis and Clostridium difficile. The present invention is in no way limited to any particular source, classification or chemical moiety of fiber, and one skilled in the relevant art will appreciate that any fiber suitable for consumption by an animal, preferably a human, may be used in the claimed beverage concentrate and beverages produced therefrom.

In preferred embodiments, a beverage concentrate in accordance with the present invention is used to produce a dispensable, frozen beverage. The dispensable, frozen beverage may be produced using any beverage system, equipment and/or machine capable of producing a FCB or FNCB and methods related thereto, including but in no way limited to those described in U.S. Pat. No. 5,575,405; U.S. Pat. No. 6,301,918; U.S. Pat. No. 6,378,740; U.S. Pat. No. 7,337,624; and U.S. Pat. No. 7,870,749. A fibrous, frozen beverage may be produced in accordance with the present disclosure and methods for producing the same may be performed under any conditions suitable for producing said beverage.

It is known in the relevant art that nutritive, “full calorie” frozen carbonated beverages (FCBs) and frozen non-carbonated beverages (FNCBs) commonly use sucrose or high fructose corn syrup (HFCS) to sweeten concentrates and the resulting beverages as well as to provide a certain amount of freezing point depression. However, a sugar free beverage concentrate lacks sucrose or HFCS and therefore an appropriate amount of freezing point depression to operate in commonly utilized, frozen beverage dispensing equipment. Without a modification to the freezing point, a sugar free concentrate would freeze into, e.g. a solid block of ice, and not exhibit the desirable, “slush like” consistency required for dispensing. Suitable replacements for sucrose or HFCS include but are not limited to sugar alcohols such as those described herein. However, in certain circumstances the quantity required to effectively control freezing point depression may exceed current guidelines for maximum use. Other ingredients commonly known to depress freezing points, such as salts or acids at levels to impact the freezing point depression, will also impact the taste and quality of the beverage.

Dietary fiber has demonstrated the necessary freezing point depression without negatively impacting taste or quality. The fiber is a soluble dextrin, low in carbohydrate content, necessary to meet requirements for a sugar free claim in the beverage in accordance with U.S. Food and Drug Administration (FDA) guidelines. Additionally, it adds body or mouth feel to the beverage, which is commonly provided by sucrose or HFCS. The fiber is also tolerant of the required beverage concentrate processing conditions, including low pH and high shear force, and is stable over the shelf life of the concentrate, all of which are favorable characteristics typically associated with sucrose or HFCS.

### I. Definitions

In order to provide a clear and consistent understanding of the terms used in the specification and claims, the following definitions are provided:

When “a” and “an” are used in conjunction with the word “comprising” or other open language in the claims, these words denote “one or more.”

As used herein, “fiber” or “dietary fiber” refers to carbohydrate compounds and chemical moieties derived from a plant or an artificial source. Fiber may be soluble, insoluble or partially soluble in terms of metabolic activity upon ingestion by an animal, such as a human. Examples of fiber compounds and chemical moieties for use in the present invention include but are not limited to oligosaccharides, polysaccharides, starches, lignin, inulin, resistant dextrins, fructans, xanthan gum, cellulose, guar gum, fructooligosaccharides (FOS), psyllium seed husk derived fiber, β-glucan, waxes, chitins, pectins and arabinoxylans. Beverage concentrates and beverages produced in accordance with the present disclosure may be described as “fibrous”, “fiber supplemented”, “fiber containing” or any alternative term that would be appreciated by a skilled artisan to describe a beverage concentrate and/or beverage produced therefrom containing fiber. In preferred embodiments, the beverage concentrates and beverages produced therefrom may be described as “good sources of fiber” in accordance with the guidelines described by the U.S. Food and Drug Administration (FDA) in 21 CFR 101 as of April 2011.

As used herein, the term “frozen” refers to the process or act of congealing a liquid into ice, an ice-containing slush or slurry and/or a beverage chilled to a “freezable” temperature at or around the freezing point of water, for example a temperature between about 32° F. (0° C.) and about 40° F. (4° C.), between about 32° F. and about 35° F. (2° C.), and between about 32° F. and about 34° F. (1° C.).

As used herein, “low calorie” refers to a beverage concentrate or beverage produced therefrom that accords with the nutrient content guidelines described by the U.S. Food and Drug Administration (FDA) in 21 CFR 101 as of October 2009.

As used herein, the term “polyol” refers to a chemical or compound comprising more than one alcohol (OH) functionality or chemical group. In some embodiments, a polyol for use with the present invention comprises a sugar alcohol, which includes but is not limited to erythritol, maltitol, mannitol, sorbitol, lactitol, xylitol, isomalt, propylene glycol, glycerol (glycerin), threitol, galactitol, palatinose, reduced gentio-oligosaccharides, reduced xylo-oligosaccharides, reduced gentio-oligosaccharides, reduced maltose syrup, reduced glucose syrup, hydrogenated starch hydrolysate (FISH) and salts thereof.

The phrase “sugar free”, or alternatively “sugar-free”, refers to a beverage or beverage concentrate containing less than 0.5 grams of sugar, e.g. sucrose, per serving.

The following examples are included to demonstrate preferred embodiments of the invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth in the following examples is to be interpreted as illustrative and not in a limiting sense.

### EXAMPLES

### Example 1

A sugar free, low calorie beverage concentrate was prepared by combining the ingredients listed in Table 1 under appropriate conditions for forming a beverage concentrate and placed in the mixing chamber of a mechanical frozen beverage dispenser. The resulting mixture was combined in an approximately 4.4:1 beverage concentrate:carbon dioxide ratio and cooled to a temperature capable of producing a dispensable, slush-like frozen carbonated beverage.

TABLE 1

Water (53.44%)
Potassium benzoate (0.17%)
Artificial colorant (0.025%)
Erythritol (18.88%)
Fiber (20.47%)
Citric acid (1.20%)
Natural and/or Artificial Flavorant (0.41%)
Sucralose (0.12%)
Glycerin (5.05%)
Yucca extract (0.0.11%)
Quillaia extract (0.13%)

### Example 2

A sugar free, low calorie beverage concentrate was prepared by combining the ingredients listed in Table 2 under appropriate conditions for forming a beverage concentrate and placed in the mixing chamber of a mechanical frozen beverage dispenser. The resulting mixture was combined in an approximately 4.4:1 beverage concentrate:carbon dioxide ratio and cooled to a temperature capable of producing a dispensable, slush-like frozen carbonated beverage.

TABLE 2

Water (53.71%)
Potassium benzoate (0.17%)
Erythritol (18.88%)
Fiber (20.47%)
Phosphoric acid (0.30%)
Caramel color (0.75%)
Aspartame (0.04%)
Acesulfame Potassium (Acesulfame-K) (0.02%)
Natural and/or Artificial Flavorant (0.41%)
Glycerin (5.05%)
Yucca extract (0.10%)
Quillaia extract (0.10%)

### Example 3

A sugar free, low calorie beverage concentrate was prepared by combining the ingredients listed in Table 3 under appropriate conditions for forming a beverage concentrate and placed in the mixing chamber of a mechanical frozen beverage dispenser. The resulting mixture was combined in an approximately 4.4:1 beverage concentrate:carbon dioxide ratio and cooled to a temperature capable of producing a dispensable, slush-like frozen carbonated beverage.

TABLE 3

Water (54.57%)
Potassium benzoate (0.17%)
Artificial colorant (0.025%)
Erythritol (18.88%)
Fiber (20.47%)
Citric acid (0.14%)
Aspartame (0.024%)
Acesulfame Potassium (Acesulfame-K) (0.016%)
Sucralose (0.005%)
Natural and/or Artificial Flavorant (0.41%)
Glycerin (5.05%)
Yucca extract (0.11%)
Quillaia extract (0.13%)

### Example 4

A sugar free, low calorie beverage concentrate was prepared by combining the ingredients listed in Table 4 under appropriate conditions for forming a beverage concentrate and placed in the mixing chamber of a mechanical frozen beverage dispenser. The resulting mixture was combined in an approximately 4.4:1 beverage concentrate:carbon dioxide ratio and cooled to a temperature capable of producing a dispensable, slush-like frozen carbonated beverage.

TABLE 4

Water (70.31%)
Sodium benzoate (0.12%)
Artificial colorant (0.074%)
Erythritol (26.51%)
Fiber (2.79%)
Citric acid (1.26%)
Natural and/or Artificial Flavorants (0.53%)
Aspartame (0.12%)
Acesulfame Potassium (Acesulfame-K) (0.083%)
Glycerin (0.15%)
Yucca extract (0.19%)
Quillaia extract (0.19%)

All of the compositions and methods disclosed and claimed herein can be made and executed without undue experimentation in light of the present disclosure. While the compositions and methods of this invention have been described in terms of the foregoing illustrative embodiments, it will be apparent to those of skill in the art that variations, changes, modifications, and alterations may be applied to the composition, methods, and in the steps or in the sequence of steps of the methods described herein, without departing from the true concept, spirit, and scope of the invention. More specifically, it will be apparent that certain agents, additives and ingredients that are similar according to their chemical, physiological and/or gustative properties may be substituted for the agents, additives and ingredients described herein while the same or similar results would be achieved. All such similar substitutes and modifications apparent to those skilled in the art are deemed to be within the spirit, scope, and concept of the invention as defined by the appended claims.

The references cited herein, to the extent that they provide exemplary procedural or other details supplementary to those set forth herein, are specifically incorporated herein by reference.

What is claimed is:

1. A sugar-free beverage concentrate comprising fiber.

2. The beverage concentrate of claim 1, wherein said beverage concentrate is capable being dispensed.

3. The beverage concentrate of claim 1, wherein said beverage concentrate is freezable.

4. The beverage concentrate of claim 1, wherein said beverage concentrate is a low calorie beverage concentrate.

5. The beverage concentrate of claim 1, wherein said fiber is present in a weight/volume percentage of between about 0.1% and about 30%.

6. The beverage concentrate of claim 1, wherein said beverage concentrate is carbonated or capable of being carbonated.

7. The beverage concentrate of claim 1, wherein said beverage concentrate is non-carbonated.

8. The beverage concentrate of claim 1, wherein said beverage concentrate further comprises one or more of sucralose, acesulfame potassium, aspartame, alitame, saccharin, neohesperidin dihydrochatcone, cyclamate, neotame, advantame and salts thereof.

9. The beverage concentrate of claim 1, further comprising a polyol.

10. The beverage concentrate of claim 9, wherein said polyol is selected from the group consisting of erythritol, maltitol, mannitol, sorbitol, lactitol, xylitol, isomalt, propylene glycol, glycerol (glycerin), threitol, galactitol, palatinose and salts thereof.

11. The beverage concentrate of claim 9, wherein said polyol is erythritol.

12. A method of making a sugar-free, fibrous carbonated beverage comprising (a) combining the beverage concentrate of claim 1 with water; and
(b) dispensing the sugar-free, fibrous carbonated beverage.

13. A method of claim 12, wherein the combination of said beverage concentrate and said water are subjected to a freezable temperature prior to step (b).

14. A method of making a sugar-free, fibrous non-carbonated beverage comprising
(a) combining the beverage concentrate of claim 1 with water; and
(b) dispensing the sugar-free, fibrous non-carbonated beverage.

15. A method of claim 14, wherein the combination of said beverage concentrate and said water are subjected to a freezable temperature prior to step (b).
